(19) United States
(12) Patent Application Publication
(10) Pub. No.: US 2026/0044889 A1
(43) Pub. Date: Feb. 12, 2026

(54) GOODS TO PERSON ORDER PICKING WITH DISCHARGE MECHANISM

(71) Applicant: Dematic Corp., Grand Rapids, MI (US)

(72) Inventor: Martin E. Schubilske, Brookfield, WI (US)

(21) Appl. No.: 19/364,672

(22) Filed: Oct. 21, 2025

Related U.S. Application Data
(63) Continuation of application No. 17/577,580, filed on Jan. 18, 2022, now Pat. No. 12,450,645.
(60) Provisional application No. 63/137,884, filed on Jan. 15, 2021.

(51) Int. Cl. G06Q 30/0601; B65G 15/22; G06Q 10/0875

(52) U.S. Cl. CPC G06Q 30/0635; B65G 15/22; G06Q 10/0875

(57) ABSTRACT

A system and method for consolidating order items into individual or batch orders within an order fulfilment workstation and discharging the order items to a takeaway device, such as a trackable segmented conveyor. The system includes a temporary holding container at the workstation and a discharge mechanism to release or transfer the contents of the temporary container to the takeaway device. The system and method reduce or eliminate the process of an operator replenishing order transport containers to the workstation once a completed order container has dispatched from the workstation. Empty order containers are supplied the workstation via the takeaway device. The empty order container is positioned adjacent the temporary container such that the discharge mechanism may transfer the order items from the temporary container into the empty order container. The discharge mechanism may transfer the order items directly to the surface of the takeaway device.

### CROSS REFERENCE TO RELATED APPLICATIONS

The present application is a continuation of U.S. patent application Ser. No. 17/577,580, now U.S. Pat. No. 12,450,645, filed on Jan. 18, 2022, which claims priority of U.S. provisional application Ser. No. 63/137,884 filed Jan. 15, 2021, all of which are hereby incorporated by reference herein in their entireties.

### FIELD OF THE INVENTION

The present invention is directed to an order fulfilment system and method, and in particular to an order fulfilment workstation having a reusable order consolidation element and discharge mechanism to transfer order items to an order container.

### BACKGROUND OF THE INVENTION

Commonly known goods to person (GTP) order fulfilment solutions include an operator whom picks inventory items to a predetermined order container that is positioned at a pick location within the GTP workstation. Once the order picking for that order container is completed, the order container is discharged or moved from the pick location to be transported away from the GTP workstation. Typically, the GTP workstation requires placement or replacement of empty order containers, such as totes or cartons, at the empty pick locations within the GTP workstation so that an order items for a new order may be picked into the newly placed empty order container. The placement or replacement of empty order containers may be done manually by the operator, requiring the operator to move or reach to retrieve an empty order container and then place it in the empty pick location, or may be done automatically, such as by a robotic arm or a transfer conveyor. Manual placement of empty order containers requires substantial manual labor and a large space to allow for sufficient movement to perform the manual operation.

### SUMMARY OF THE INVENTION

The present invention provides a system and method for consolidating order items for a customer order and automatically discharging the consolidated order into an empty, or partially completed, order takeaway container, such as a tote or a shipping carton. The system and method substantially reduce or eliminate the need for automated or manual placement of the order takeaway containers at the picking location, or an order fulfillment workstation, such as in the form of a goods-to-person (GTP) workstation, for example. The order items or components are placed in an order consolidation element or consolidator, such as in the form of a platform or temporary collection/holding compartment or container, which is coupled with a discharge mechanism. The discharge mechanism transfers the order components from the platform to the takeaway device, and may include a chute, pushing arm, and/or tilting tray, for example. After the discharge mechanism transfers the items to the takeaway device, the platform is reused to collect the components of the next order assigned by the order management system. The method is repeated and the operator is never required to manually place or replace an empty order container at a picking location. The takeaway device may include a segmented conveyor with trackable conveyor segments or other form of order collection device that is individually addressable and/or trackable by an order management system to automatically take away the order components in a completed order group or partially complete order group to a downstream solution. Alternatively, the takeaway device could be any other suitable conveyance or transport system, such as A-frame type collection conveyors, monorail or Power and Free conveyors, conveyors marketed and sold by BOSCH®, such as those marketed under the brand REXROTH by Bosch Rexroth AG of Stuttgart Germany, and conveyors with shuttles containing a bucket or tray, for example.

The method includes a picking process to consolidate order items or components by picking/collecting the items in the platform that is actuatable or activated by the discharge mechanism to transfer the order components onto a takeaway device or into an order container at the takeaway device. The operator picking the orders places the order items into one or more platforms at a workstation. The operator may be a human or a robot. Preferably, each platform is utilized for a single/individual order, “pseudo order” collection, or a partial individual order collection. “Pseudo order” collections may include a superset of orders or batch of orders, such as an entire set of e-commerce orders prepared for a single store location (e.g. markets, convenience stores, and retail stores). For example, a pseudo order may include a collection of multiple customer orders that are each pre-consolidated. The pre-consolidated orders are all picked to one of the platforms, to form a superset, batch, or pseudo order. The pseudo order represents a collection of orders to be forwarded to the store location such that the store's orders are already consolidated and ready for pickup at the store location by the store's respective customer.

Once all of required components of the individual order/partial order/pseudo order are collected in the platform, the operator indicates that the order is complete and the items are released via actuation of the discharge mechanism. For example, the discharge mechanism may include a tilting mechanism to tilt the platform so that the components release due gravity onto a tracked segmented conveyor or into a tracked order container supported at the conveyor below the platform. An order management system, including a computer, tracks each of the tracked segments of the conveyor and each tracked order container that is present within the order fulfilment system. Optionally, the takeaway device may be an autonomous mobile robot (AMR).

Optionally, the collection of order items may be discharged directly onto the surface of the segmented conveyor to be transported to a downstream location or process (e.g. packing station). The order management system tracks the collection of order items based on its location on one of the tracked segments of the conveyor. The collection of order items may be transported by the conveyor to another/downstream discharge mechanism where the components are transferred to an order tote or order packaging device.

The system and method are particularly advantageous for labor and floor space reduction, and may reduce labor and/or floor space requirements by as much as 30% or more. The system and method are particularly advantageous for the elimination of an operator needing to manually replace the completed and released order container with an empty container and/or automated mechanisms to automatically replace single use empty container at each workstation. This enables the operator to increase the number of items that can be picked/consolidated for orders (e.g. single order, pseudo orders, or partial orders) within a given time period (e.g. one hour period), thus increasing throughput of the operator and the order fulfilment workstation. The system and method are particularly well suited for order fulfilment applications using automated storage and retrieval systems (ASRS), such as automated grid storage systems like those marketed under the trademark AUTOSTORE® by Autostore Technology AS of Norway.

According to one form of the present invention, an order fulfillment system includes an order management system having a computer adapted to control the order fulfilment system. The system includes one or more order fulfilment workstations for segregating inventory items or components into individual orders (or batch/pseudo orders) to fulfil orders as directed by the order management system. The order fulfilment system includes a takeaway device to transport order containers to and from the workstation. Order containers may include completed order containers with single orders or pseudo orders, partially completed order containers, and empty order containers. Each of the workstations includes multiple order consolidation elements or consolidators, such as in the form of platforms or temporary holding containers, disposed adjacent to the takeaway device and configured to receive order items for a particular order as directed by the order management system. The workstation includes an order discharge mechanism disposed at each of the platforms. The discharge mechanism is selectively operable to transfer the order items from the respective platform to an order container positioned at the takeaway device adjacent to the platform. The order management system may index empty order containers adjacent to platforms by about the time that the order picking operation at the particular platform is completed. Alternatively, the discharge mechanism may transfer the order items directly onto the surface of the takeaway device, without the use of an order container.

In one aspect the platform includes at least one chosen from a bin, a tote, a tray, a shelf, a conveyor belt, a conveying chain, a monorail, a cart, and a pouch. In another aspect, the order discharge mechanism includes at least one of tilt tray forming a portion of the platform, a pivoting/tilting shelf that tilts the entirety of platform toward the takeaway device, a dropout door disposed at a bottom portion of the platform, a pusher arm, and a selectively operable conveyor that directs the order items toward the takeaway device.

In still another aspect, the takeaway device includes a segmented conveyor wherein each segment of segmented conveyor is selectively operable and/or individually addressable by the order management system. Optionally, container brakes or barriers, such as pop-up stoppers may be provided at downstream ends of each segment of the conveyor to provide a temporary barrier to impede order containers along the conveyor. The temporary barriers may be controllable by the order management system.

In yet another aspect, the order management system includes a “pushing” logic, or in other words a prioritization and tracking logic, performed by the computer and adapted to track each of the order containers and direct and move (i.e. “push”) the order containers to a desired location within the order fulfilment system. The push logic, as performed by the computer, controls the conveyor to direct each of the orders to a desired location, such as a downstream packing station. The push logic is operable to prioritize the movement or transfer of completed and partially completed order containers from platforms onto the conveyor versus the system's need for empty order containers as required at platforms and/or additional downstream workstations that are downstream of a particular platform that is supporting/buffering a completed or partially completed order container.

According to another form of the present invention, a method for consolidating order items into order containers includes transporting an empty order container to an order fulfilment workstation. The method includes positioning the empty order container adjacent to a consolidation element or consolidator, such as in the form of a platform or temporary holding container, of the workstation. The platform is configured to receive order items for a particular order as directed by an order management system. Once the platform has been filled with the required items for the order, the method includes transferring the order items from the platform to the empty order container with a discharge mechanism and subsequently transporting the completed order container downstream of the order fulfilment workstation with a takeaway device, which may include a segmented conveyor.

In one aspect, the method includes prioritizing and tracking the empty order containers along the segmented conveyor in a manner that optimizes the conveyor capacity while providing a sufficient supply of empty order containers to the order fulfilment workstations to reduce starvation at platforms that have recently discharged a completed collection of order items onto the takeaway device.

In another aspect, the method includes prioritizing resource utilization by balancing the transfer of completed order containers with the need for empty order containers in a manner that permits completed order containers from upstream order fulfilment workstations to be released downstream of the order fulfilment workstation without starving empty order containers downstream workstations. In one aspect, the supply of empty order containers to empty platforms at is prioritized over the release and transport of completed order containers from their respective platform.

Accordingly, the system and method for consolidating orders in an order fulfilment system reduces or eliminates the need for an operator to supply or replenish empty order containers to picking locations within a workstation. The system includes a temporary compartment to receive the order components from the operator, and once the order components are all present, a discharge mechanism transfers the order components from the temporary compartment into an empty order container that is indexed adjacent to the temporary compartment. The filled order container is then released downstream along the conveyor and is tracked by the order management system. Alternatively, the order components may be transferred by the discharge mechanism directly onto the conveyor wherein the components are tracked by the order management system until they reach a desired destination.

These and other objects, advantages, purposes and features of this invention will become apparent upon review of the following specification in conjunction with the drawings.

### BRIEF DESCRIPTION OF THE DRAWINGS

FIG. 1 is a diagrammatic plan view of an order fulfilment system in accordance with the present invention;

FIG. 2 is a top-side perspective view of an order fulfilment system having a goods-to-person (GTP) workstation with discharge mechanisms, in accordance with the present invention;

FIG. 3 is a diagram of a method for consolidating order items in an order fulfilment system, in accordance with the present invention; and

FIG. 4 is a top-side perspective view of an order fulfilment system having a typical goods-to-person (GTP) workstation, as known in the prior art.

### DESCRIPTION OF THE PREFERRED EMBODIMENTS

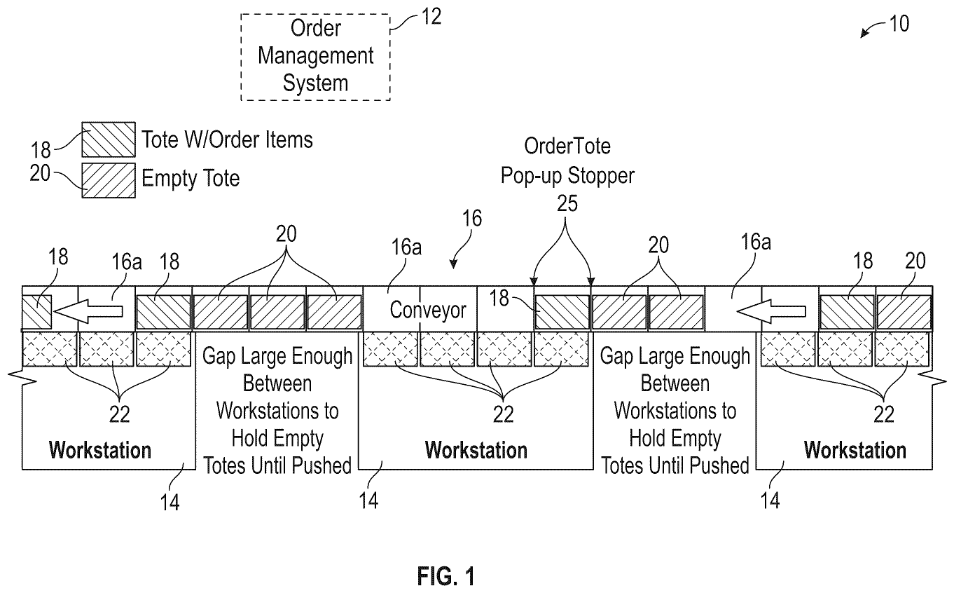

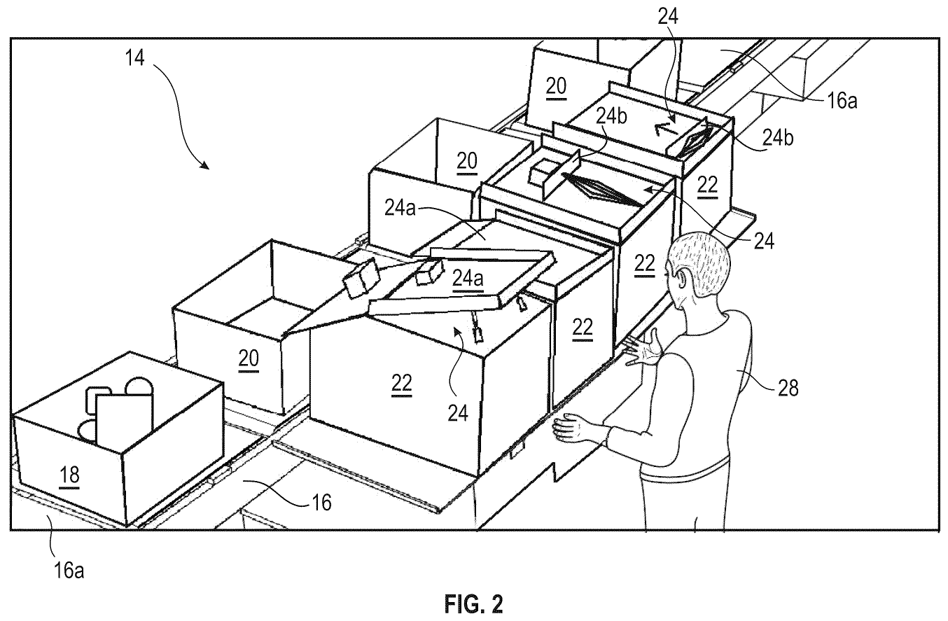

Referring now to the drawings and the illustrative embodiments depicted therein, an order fulfillment system 10 and a method 100 are provided for consolidating order items or components for a particular customer order (FIGS. 1-3). The fulfilment system 10 includes an order management system 12 having a computer that is adapted to control the order fulfilment system 10 based on the requirements of customer orders. The fulfilment system 10 includes one or more order fulfilment workstations 14 for consolidating or segregating individual inventory items into individual orders and/or batch orders as directed by the order management system 12. The fulfilment system 10 includes a takeaway device or conveyor, such as in the form of a segmented conveyor 16, to transport orders and/or order containers to and from the order fulfilment workstations 14. The orders may be transported directly on the conveyor 16, such as in a collection of order items making up the completed order, or may be transported along the conveyor 16 within order containers. The order containers may include completed order containers 18, partially completed order containers, or empty order containers 20. Each of the order fulfilment workstations 14 includes multiple order consolidation elements or consolidators, such as in the form of platforms or temporary holding containers 22, adjacent to the conveyor 16. Each platform 22 is provided for receiving order items for a particular order as directed by the order management system 12. Each platform 22 represents a picking location to which a picker may place one or more order items for one or more orders (e.g. individual orders, batch orders, pseudo orders, etc.). The workstation 14 includes an order discharge mechanism 24, such as in the form of a tilt or drop dumper 24a, pusher arm 24b and/or a chute 24c, at each of the platforms 22 (FIG. 2). The order discharge mechanism 24 is operable to transfer or release the order items from the respective platforms 22 directly to the conveyor 16 surface or to an empty order container 20 positioned on the conveyor 16 adjacent to the order discharge mechanism 24. The platforms 22 are reusable to fill new orders without the need to replace an order container at the workstation 14 such that after the discharge mechanism 24 has released the order items and returned the platform 22 to its item holding position, the picker may place items on the platform 22 for another order to be filled.

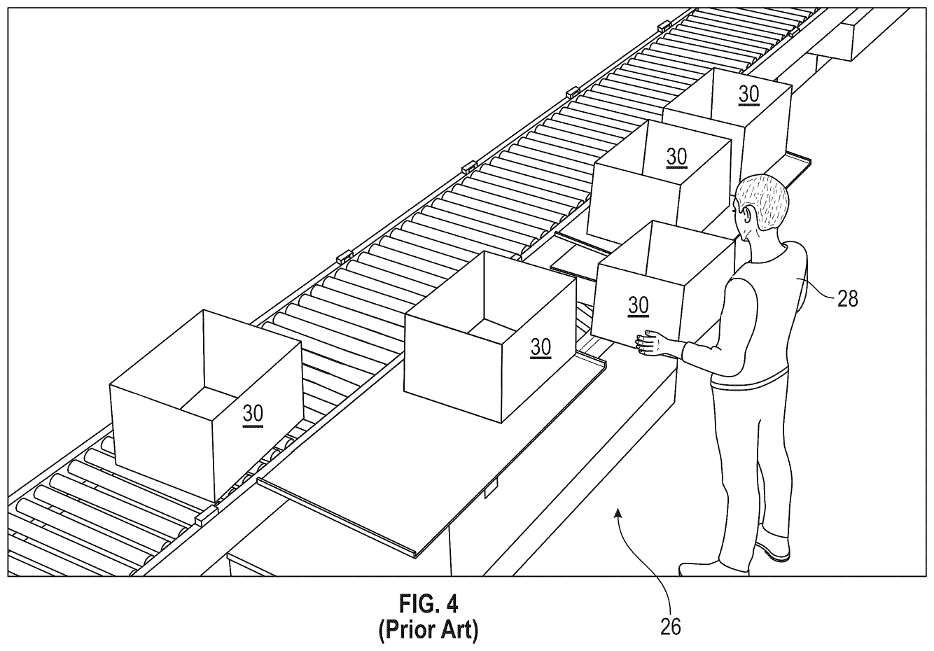

The order management system 12 controls the conveyor 16 to index empty order containers 20 (or partially filled/completed containers) adjacent to platforms 22 to provide an empty order container 20 at about or nearly simultaneous to when the order picking operation at the particular one of the platforms 22 is completed and the completed order container 18 is discharged onto the conveyor 16 and moved downstream. The empty order containers 20 (or partially filled order containers) supported on said conveyor 16 may each define an order reception location at which order items may be put to/transferred to from the platform 22. The system 10 and method 100 reduce or substantially eliminate the need for an operator to either transfer completed order containers 18 from the workstation 14 or to replenish, replace, or supply empty order containers 20 to the workstation 14 (which may be required in commonly known goods-to-person order fulfilment workstations, such as the exemplary workstation 26 illustrated in FIG. 4, in which the operator 28 places order items directly into one of multiple order containers 30 and the operator 28 must manually transfer completed containers to the conveyor and/or manually replace the order container 30 when a completed container is removed from the workstation 26).

The platforms 22 may include a bin, a tote, a tray, a shelf, a conveyor belt, a conveying chain, a monorail, a cart, a pouch, or any other suitable consolidation container such as commonly known and commercially available. The order discharge mechanism 24 may include at least one of a tilt tray 24a (FIG. 2) forming a portion of the platform 22, a pivoting/tilting shelf that supports the platform 22, a chute or slide 24c (FIG. 2) adjacent to or forming a portion of the platform 22, a pusher arm 24b (FIG. 2) operable to push items off the platform 22 toward the conveyor 16, a dropout door at a bottom portion of the platform 22, a selectively operable conveyor, and/or any other suitable device for discharging, transferring, or releasing the order components from the platform 22 to the conveyor 16 or into an empty order container 20 adjacent the platform 22. While it may be one scenario that order items are discharged from the platform 22 to an empty order container 20, it will be appreciated that the items may be discharged to a partially filled order container that already contains some order items, such as from an upstream process (e.g. an upstream workstation).

Individual segments 16a of the segmented conveyor 16 may each be selectively operable and/or individually addressable by the order management system 12. The individual segments 16a may each define an order reception location at which order items may be supported directly on the conveying surface of the conveyor 16. Brakes or barriers may be provided with the conveyor 16, such as in the form of pop-up stoppers 25 positioned at downstream ends of each segment 16a to provide a temporary barrier impeding movement of order items or order containers 18, 20 along the conveyor 16 (FIG. 1). The barriers 25 are individually addressable and controllable by the order management system 12. While the takeaway device of the illustrative embodiment of FIG. 1 is depicted as a segmented conveyor 16, it will be appreciated that any suitable conveyance or transportation device may be utilized to transport the order container to and from the workstation 14. For example, roller conveyors, continuous belt conveyors, pouch conveyors, monorail conveyors, power and free conveyors, shuttle/tray conveyors, or the like and/or or autonomous robotic vehicles (e.g. an autonomous mobile robot (AMR)) are contemplated to takeaway or deliver order containers to/away from the workstations 14.

The order management system 12 includes a “pushing” logic, or in other words a prioritization and tracking logic, performed by the computer and adapted to track each of the orders and/or order containers 18, 20 and to direct, move, or push the orders/containers to a desired location within the order fulfilment system 10, such as to a downstream order packaging process, for example. The computer tracks each segment 16a of the conveyor 16 in order to prioritize the resource utilization within the system 10. Preferably, the pushing logic of the management system 12 controls the order fulfilment 10 to only release/transfer completed orders from their respective platform 22 to an empty order container 20 on the conveyor 16 when all downstream workstations 14 and/or platforms 22 of the downstream workstations have sufficient empty order containers 20 immediately available to them (i.e. an empty container 20 at a segment 16a of the conveyor 16 adjacent one or more of the workstations platforms or immediately upstream of the particular workstation 14). As such, the pushing logic controls the conveyor 16 and workstations 14 to move completed order containers 18 downstream as efficiently as possible without impeding the arrival of empty order containers 20 that are required downstream of a particular workstation 14. In other words, a particular completed order 18 may be held or buffered at its respective platform 22 to permit empty order containers 20 to pass along the conveyor 16 to downstream platforms 22 within the same workstation 14 or to downstream workstations 14.

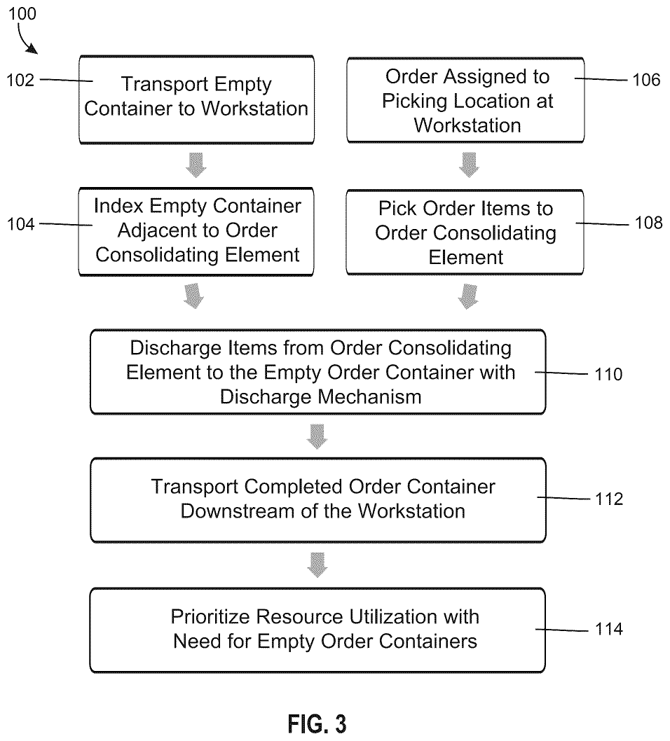

Referring to the illustrative embodiment of FIG. 3, a method 100 is provided for consolidating order items into order containers and includes transporting 102 an empty order container to an order fulfilment workstation, such as the workstation 14 described above and illustrated in FIG. 1. The method 100 includes positioning or indexing 104 an empty order container 20 adjacent to an order consolidation element or picking location, e.g. a platform or temporary holding container 22, of the workstation 14 (FIG. 1). An order management system 12 assigns 106 an order to a platform 22 at the workstation 14 and an operator, either a human or a robot, picks 108 the order items to the assigned platform 22. The platform 22 is provided to receive and retain order items from the operator for the assigned order. When the platform 22 has been filled with the required items for the order, the method 100 includes transferring or discharging 110 the order items from the platform 22 to an empty order container 20 with a discharge mechanism 24. The completed order container is then transported 112 downstream of the order fulfilment workstation 14.

Transporting 102 of the empty order container is performed with a takeaway device, such as a segmented conveyor 16 or an autonomous mobile robot (AMR), for example. Transporting 102 may include indexing empty order containers 20 along the segmented conveyor 16 to optimize the conveyor capacity while providing sufficient empty order containers 20 to the order fulfilment workstation 14 to reduce starvation at the platforms 22 that have completed processing their previous order. The method 100 may include prioritizing or balancing 114 resource utilization in regard to the quantity and location of completed order containers 18 present on the conveyor 16 with the need for empty order containers 20 at the platforms 22. For example, resource utilization may be prioritized in a manner that permits completed order containers 18 from upstream order fulfilment workstations 14 to be released downstream while optimizing the arrival of empty order containers 20 to a particular order fulfilment workstation 14. For example, if a downstream workstation 14 requires empty order containers 20 at one or more platform 22, the method 100 may prioritize 114 sending empty order containers 20 to that downstream workstation 14, in lieu of releasing/transferring completed order containers 18 from upstream workstations 14 onto the conveyor 16. In such a scenario, the completed order containers 18 at upstream workstations 14 are held or buffered at their respective platform 22 to permit the prioritized empty order containers 20 to pass those upstream workstations 14. The completed order containers 18 at the upstream workstations 14 may be released/transferred to the conveyor 16 once the prioritized empty order containers 20 have passed. In other words, because the conveyor 16 is utilized for moving inbound empty/partially empty order containers 20 as well as outbound completed/partially completed order containers 18, the method 100 is well-suited for prioritizing the utilization of the conveyor 16 to execute both inbound and outbound processes. For example, the transfer 110 of outbound, completed order containers 18 to the conveyor 16 may be balanced against the transport 102 of inbound, empty order containers to workstations 14 in a manner that prioritizes the supply of empty order containers 20 to empty platforms 22 over the release 110 and transport 112 of completed order containers 18 from their respective platforms 22.

Alternatively, the steps of method 100 providing an empty order container may be omitted, and the discharge mechanism 24 may discharge/transfer the collection of order components directly from the platform 22 onto the conveyor 16. In such an embodiment, the order management system 12 tracks the order components as they move along the trackable segments 16a of the conveyor 16. The collection of order components are transported directly on the conveyor 16 to a downstream process, such as another workstation 14 or an order packaging process, for example.

Thus, a system and method are provided for picking individual items and consolidating those items into individual orders within an order fulfilment workstation. The method includes discharging the order items for the individual order to a takeaway device, such as a trackable segmented conveyor. The system includes a platform or temporary holding container at the workstation and a discharge mechanism to release or transfer the order contents at the platform onto the segmented conveyor. The system and method substantially reduce or eliminate the need for an operator to (i) manually transfer completed order containers to the segmented conveyor or (ii) manually supply or replenish order transport containers to the workstation once a completed order container has been dispatched from the workstation. As such, labor and space requirements may be significantly reduced by alleviating the operator from having to transfer and/or replenish order containers, thereby increasing operator and workstation throughput and improving resource efficiency. The system and method may also track the orders and/or order containers to prioritize and optimize resource usage, such as by balancing and prioritizing completed order container discharge processes versus empty order container arrivals at the workstation.

Changes and modifications in the specifically described embodiments can be carried out without departing from the principles of the present invention which is intended to be limited only by the scope of the appended claims, as interpreted according to the principles of patent law including the doctrine of equivalents.

1. An order fulfillment system comprising:
an order fulfillment workstation having a plurality of temporary collection compartments configured to allow an operator to pick from inventory items for each single order of a plurality of orders into a selected temporary collection compartment of said plurality of temporary collection compartments;
a takeaway device to transport the orders in respective totes to and from said order fulfillment workstation, said respective totes corresponding to said temporary collection compartments; and
an order discharge mechanism associated with each of said temporary collection compartments, each of said order discharge mechanisms configured to transfer the order items from each of said selected temporary collection compartment to a respective tote on said takeaway device when each single order has been completed in said selected temporary collection compartment.

2. The order fulfillment system of claim 1, wherein said takeaway device is an autonomous mobile robot (AMR) device.

3. The order fulfillment system of claim 2, wherein said AMR is configured to receive order items from said discharge mechanism and transport and discharge the order items to a downstream process.

4. The order fulfillment system of claim 2, wherein said takeaway device comprises a plurality of AMRs, and wherein each AMR is configured to transport a selected one of the totes to and from the order fulfillment workstation.

5. The order fulfillment system of claim 1, wherein said plurality of temporary collection compartments are adjacent to said takeaway device and disposed between said operator and said takeaway device.

6. The order fulfillment system of claim 1, wherein said discharge mechanisms comprise at least one chosen from a tilt tray, a pivot shelf, a dropout door, a pusher arm, and a selectively operable conveyor.

7. The order fulfillment system of claim 1, wherein said takeaway device comprises a segmented conveyor having a plurality of independent conveyor segments in spaced arrangement with one another and each of said conveyor segments is individually addressable and/or selectively operable by an order management system comprising a computer.

8. The order fulfillment system of claim 1, further comprising an order management system comprising a computer adapted to control said order fulfilment system, and wherein each temporary collection compartment is configured to receive order items for a particular order as directed by said order management system.

9. The order fulfillment system of claim 8, further comprising a plurality of order reception locations disposed at said takeaway device, and wherein totes for receiving the order items from said selected temporary collection compartments are disposed at said order reception locations, and wherein said order management system comprises a prioritization and tracking logic executed by said computer and adapted to track each of the totes present on said takeaway device and at said reception order locations, wherein each tote present on said takeaway device is tracked relative to a respective order reception location at which the tote is positioned.

10. The order fulfillment system of claim 9, wherein said prioritization and tracking logic controls said takeaway device to direct each of the totes to a desired one of said order reception locations.

11. A method for consolidating order items, said method comprising:
providing a plurality of temporary collection compartments at an order fulfillment workstation;
associating a discharge mechanism with each of the temporary collection compartments;
providing a takeaway device operable to convey totes to and from the workstation adjacent the temporary collection compartments, wherein the temporary collection compartments are disposed between an operator location of the workstation and a travel path of the totes as conveyed by the takeaway device;
picking order items for a single order into a selected one of the temporary collection compartments; and
transferring the order items from the selected one of the temporary collection compartments via the associated discharge mechanism to a selected tote on the takeaway device.

12. The method of claim 11, wherein said takeaway device comprises an autonomous mobile robot (AMR) device configured to convey a selected tote to and from the order fulfillment workstation.

13. The method of claim 12, wherein said takeaway device comprises a plurality of AMRs, and wherein said method comprises positioning each of the AMRs adjacent a respective one of the temporary collection compartments.

14. The method of claim 12, wherein said method comprises conveying the selected tote with the AMR adjacent to the selected one of the temporary collection compartments prior to said transferring the order items from the selected one of the temporary collection compartments via the associated discharge mechanism to the selected tote, and conveying the selected tote away from the selected one of the temporary collection compartments after said transferring the order items from the selected one of the temporary collection compartments via the associated discharge mechanism to the selected tote.

15. The method of claim 11, wherein said picking order items for a single order into a selected one of the temporary collection compartments comprises picking all order items required for the single order.

16. The method of claim 12, wherein said transferring the order items from the selected one of the temporary collection compartments via the associated discharge mechanism to the selected tote on the takeaway device, comprises transferring all order items required for the single order from the selected one of the temporary collection compartments.

17. The method of claim 11, wherein the discharge mechanism comprises at least one chosen from a tilt tray, a pivot shelf, a dropout door, a pusher arm, and a selectively operable conveyor.

18. The method of claim 11, further comprising providing an order management system comprising a computer, and wherein said order management system is configured to control (i) the takeaway device to convey totes to and from the workstation adjacent the temporary collection compartments, and (ii) the discharge mechanisms to transfer order items from the temporary collection compartments to the totes.
